(19) United States
(12) Patent Application Publication
(10) Pub. No.: US 2014/0053463 A1
(43) Pub. Date: Feb. 27, 2014

(54) SYSTEMS, METHODS, AND DEVICES FOR INSULATED GRAIN GERMINATION

(71) Applicant: Abdessamad Khaled, Sugar Hill, GA (US)

(72) Inventor: Abdessamad Khaled, Sugar Hill, GA (US)

(21) Appl. No.: 13/592,125

(22) Filed: Aug. 22, 2012

(51) Int. Cl. A01G 31/06

(52) U.S. Cl. 47/61

(57) ABSTRACT

An insulated grain germination unit is disclosed. The insulated grain germination unit is comprised of a plurality of insulated doors, each insulated door corresponding to a particular tray, or set of trays, and pivoting to permit access to the tray(s) housed within the unit thus minimizing impact to the internal growing environment for the remaining trays. Trays are dimensioned to facilitate manual removal of harvest-ready sprouted grains.

### FIELD OF THE INVENTION

The technology described herein relates generally to the production of plants. In particular the technology described herein pertains to systems, methods and devices directed to technology for production of plants from food grains for animal consumption, such as forage.

### BACKGROUND OF THE INVENTION

Hydroponics is the soilless growing of plants. The year-round production of edible plants for humans or livestock, especially due to constraints of adverse climates, terrain or electricity/water access, is facilitated by the use of hydroponic assemblies.

Hydroponics is an especially useful technique for producing food for livestock. The advantages of the use of hydroponics to produce livestock are that:
a. fresh food is available all year,
b. the food that is available is free from undesirable materials such as weeds, wild garlic and onion plants, insects, dust, insecticides, and radioactive fallout,
c. the product is free of soil so the animals can eat the entire plant, root and all.

Properly designed hydroponic devices can yield an enormous output of plant material in a short time. The yield is large and quick because of the opportunity to control germination, temperature, light, and food for the plants. It is not unusual to produce a nine-inch growth of grass from barley seed in 7 days, and the growth of grass produces a seven-fold increase in weight over the weight of the seeds that were employed.

Hydroponics is a subset of hydro-culture and is a method of growing plants using mineral nutrient solutions, in water, without soil. Terrestrial plants may be grown with their roots in the mineral nutrient solution only, or in an inert medium, such as perlite, gravel, mineral wool, expanded clay or coconut husk.

Some of the reasons why hydroponics is being adapted around the world for food production are the following:
a. No soil is needed for hydroponics
b. The water stays in the system and can be reused—thus, lower water costs
c. It is possible to control the nutrition levels in their entirety—thus, lower nutrition costs
d. No nutrition pollution is released into the environment because of the controlled system
e. Stable and high yields
f. Pests and diseases are easier to get rid of than in soil because of the container's mobility
g. It is easier to harvest
h. No pesticide damage

Today, hydroponics is an established branch of agronomy. Progress has been rapid, and results obtained in various countries have proved it to be thoroughly practical and to have very definite advantages over conventional methods of horticulture.

There are two chief merits of the soil-less cultivation of plants. First, hydroponics may potentially produce much higher crop yields. Also, hydroponics can be used in places where in-ground agriculture or gardening is not possible.

Hydroponics also saves water; it uses as little as 1/20 the amount as a regular farm to produce the same amount of food. The water table can be impacted by the water use and run-off of chemicals from farms, but hydroponics may minimize impact as well as having the advantage that water use and water returns are easier to measure. This can save farmers money by allowing reduced water use and the ability to measure consequences to the land around a farm.

In growing fodder crops such as maize and barley or the like, the growth cycle may be completed under optimum conditions within about seven days. Of this period some two days comprises the germination period, and is best carried out under dark or subdued light conditions, and about four days comprises a high growth period, which is best carried out at high ambient light levels. The seventh day of the cycle includes such operations as seed preparation and collection of the fodder, which may usually be effected outside of the greenhouse.

There have been many systems proposed for the intensive production of fodder in order to provide feed for livestock. Systems have been proposed that range from simple trays in which seeds are grown, through hydroponic systems to various automated systems. The main difficulty with all of these systems for producing fodder is achieving sufficient fodder production in an economical manner.

Systems involving the production of fodder in trays are a batch-wise process that results in the harvesting of large quantities of fodder which needs to be stored for later use. The next batch of feed only becomes available once the next crop of fodder has been grown ready for harvest.

These batch-wise systems may be staggered in planting and result in a more evenly distributed production of fodder. However these systems require considerable manipulation of the trays at planting, throughout the growth of the fodder and upon harvesting. The manipulation of trays of fodder is often difficult because of the weight of the trays as the fodder grows and is often generally inconvenient, labor intensive and results in an uneven growth of fodder.

Automated units have been constructed in which trays are mechanically moved along a conveyor system whereby trays sown with seeds are picked up and trays of fodder are then harvested from the other end of the production unit. The capital outlay required for such a system is often prohibitive and as a result automated systems have not generally found acceptance in the production of fodder for livestock.

A number of hydroponic systems have also been used to produce fodder. These systems require the controlled supply of nutrients to the germinating seeds and growing sprouts and are generally used in a batch-wise cropping system.

The systems described above all have inherent problems or constraints that make the production of fodder for use as a feed for livestock uneconomic or impractical.

The size and cost of a hydroponic system and the controlled provision of nutrients is generally either uneconomic or labor intensive for most small farmers.

Some systems use trays that have to be pushed/trusted forward of the box each day a new set of trays is introduced. This requires a considerable effort to push the heavy/sprouted grains several feet each day and can be prohibitive to someone who doesn't have the required body build and strength to power the trays forward.

Conventional units currently on the market involve the forcing of trays from the back of the unit to the front of the unit; this requires the trays to be moved daily; the physical requirement to move such heavy trays is very demanding. Also, by opening the large central doors, all the trays are exposed and the unit loses its optimally controlled climate, which increases cost in order to return the interior temperature and humidity back to the desired climate once the doors are closed.

Conventional units are impractical in many developing countries which are characterized by an abundance of sunshine, a lack of rainfall, and particularly in rural districts of third world countries, absence of reliable electrical energy and/or access to pressurized water.

Another problem/constraint is that current units on the market have large doors that expose all trays when these doors are opened for access to the product; by opening the doors, the unit quickly loses its growing climate; increased costs are incurred to bring the internal climate of the unit back to the desired temperature and humidity once the access doors are closed.

These and other problems need to be addressed.

Related patents and published patent applications known in the background art include the following:

U.S. Pat. No. 1,454,422, issued to Abe on May 8, 1923, discloses a process for making edible malt and sprouts in an enclosure utilizing a drainage system which flows water into boxes situated on shelves that are sloped uniformly for drainage.

U.S. Pat. No. 3,991,514, issued to Finck on Nov. 16, 1976, discloses a device for hydroponic growth of plants which includes an elongated chamber having an inlet door, an outlet door, and an interior designed to support vertically spaced trays which are arranged to be advanced one tray-length each day from the inlet door toward the outlet door. The trays are illuminated with light adapted to promote photosynthesis after advancing three tray-lengths through the chamber. The chamber is at least seven tray-lengths long and is provided with sprays above the top row of trays. The trays have corrugated bottoms with drain holes in the lowermost portion of each corrugation.

U.S. Pat. No. 5,101,593, issued Bhatt on Apr. 7, 1992, discloses a solar greenhouse which includes walls and a roof which together with a floor form a closed chamber. Windows are provided to permit the entry of light into a major part of the chamber where growth will occur while restricting light to a minor portion thereof where germination of seeds occurs. Racks for stacked growing trays are provided; preferably the upper part of the chamber is used for germination. The greenhouse further includes apparatus for accumulating solar energy in the form of electrical energy so as to drive irrigation pumps and fans and also in the form of thermal energy to assist in maintaining desired temperatures in the chamber.

U.S. Published Patent Application No. 2009/0235583, inventor Colless et al., published on Sep. 24, 2009 discloses a transportable fodder production unit comprising an insulated container wherein said insulated container contains a racking system, an irrigation system, a lighting system and a thermal control system, said racking system having a plurality of shelves extending from the rear of the container to the front of the container, said shelve being of sufficient width to receive at least one fodder growing tray and of sufficient depth to receive a predetermined number of rows of trays to cycle through the container in a growing period whereby seeded trays can be loaded onto the rear of the shelves and trays with mats of grown fodder can be removed from the front of the shelves, said trays being urged forward by an operator as the fodder progresses through the growing period and wherein the irrigation system comprises a plurality of spray heads positioned in the racking system for periodically spraying each tray with a predetermined volume of water, the lighting system maintains a predetermined illumination and the thermal control unit maintains the temperature within a predetermined temperature range.

The foregoing patent, patent publication and non-patent information reflect the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

The technology described herein pertains to insulated grain germination units that facilitate the year-round growing of fodder for livestock, as well as live plants for humans.

In an exemplary embodiment the insulated grain germination unit is comprised of an exterior structure with a predetermined amount of interior insulation to facilitate the creation of optimum growing temperature and humidity regardless of weather conditions outside of the structure. The exterior structure is further comprised of an access portal, e.g. access doors, for maintenance of the internal systems within the unit.

The insulated grain germination unit is further comprised of at least one shelving system comprised of multiple shelves configured for housing a plurality of trays. The trays and shelves are configured for facilitating drainage of nutrient-rich effluents through the trays.

The insulated grain germination unit is further comprised of a plurality of insulated doors, each insulated door corresponding to a particular tray, or set of trays, and pivoting to permit access to the tray(s) housed within the unit. Each door is further comprised of a lock assembly for securing the door. Types of lock utilized include, but are not limited to, a hand-pressure snap-lock, a key lock, a turn-handle lock, a key card lock, or a time lock.

In some embodiments the insulated door is further comprised of a viewing window configured for observing the contents of the corresponding tray.

In some embodiments the insulated grain germination unit is further comprised of a hinged master door comprised of a vertical array of the insulated doors. When the hinged master door is opened, e.g. by a handle, all the trays behind the insulated doors are accessed. This facilitates access to all trays through the opening of one door, instead of having to individually open each insulated door.

The insulated grain germination unit is further comprised of a plant growth support system that provides moisture, nutrients and proper growing conditions for the grains disposed in the trays.

The plant growth support system is comprised of an irrigation-nutrient system and a climate control system. In some embodiments the plant growth support system is further comprised of a lighting system.

The irrigation-nutrient system is configured for providing nutrient rich liquid to the germinating grain in each tray. The irrigation system may provide the liquid in the form of a fog, a mist, droplets etc., as desired. The irrigation system is configured to capture excess liquid after it has provided moisture and nutrients to the grains and to return the excess liquid again to each tray.

The irrigation system is further configured for capturing husks and other material that may clog the flow of liquid and for facilitating the removal of clogging material. The irrigation system may be comprised of an overhead sprinkler system or Nutrient Film Technic (NFT) or ebb-and-flow or any other mechanism or technique that provides a predetermined water quantity in preset time intervals.

The irrigation system is further comprised of a water shut-off valve for each tray (or group of trays), as well as a master shut-off valve for an array of doors.

In some embodiments the irrigation system is further comprised of a water reservoir. The nutrients can be supplied by a separate nutrient supply source that is connected to the irrigation system or can be integrated into the irrigation system.

In some embodiments the irrigation-nutrient system is further comprised of a water pump configured to provide pressurized water when access to pressurized water is not available.

The climate control system is comprised of a temperature subsystem which is configured for providing a temperature range that facilitates the germination and growth of the grains. The climate control system is further comprised of at least one air movement system, e.g., at least one fan, for inducing a flow of air within the interior of the unit to facility uniform temperature and humidity.

In some embodiments a lighting system is provided and is comprised by a plurality of light sources configured for generating light conducive for stimulating growth of the germinating grain as well as providing optimum color in each seedling.

In some embodiments alternate sources of power are provided, e.g., at least one backup battery, solar-power assemblies, wind-power assemblies. These can serve as backup power sources, sole power sources or complimentary power sources depending on the environment or geographical location of the grain germination unit.

The solar-power assembly is comprised on solar panels disposed on or near the exterior of the unit to capture sunlight and convert the sunlight into electrical energy. The solar-power assembly is further comprised of at least one battery assembly within the unit configured for storing the electrical energy generated by the solar panels and for providing energy to the operational assemblies within the unit.

The wind-power assembly is further comprised of at least one wind turbine configured to convert wind energy into electrical energy. The electrical energy thus produced can be stored in at least one battery assembly within the unit configured for storing the electrical energy generated by the wind turbine and for providing energy to the operational assemblies within the unit.

In an exemplary embodiment of the technology described herein the insulated grain germination unit is further comprised of a monitoring, reporting and alerting system to ensure continuous proper growing conditions for the grains disposed in the trays.

The monitoring, reporting and alerting system is comprised of a monitoring subsystem, an alerting subsystem and a reporting subsystem.

The monitoring subsystem is comprised of a sensor system configured to sense the operating conditions of the insulated grain germination unit. The sensors monitor the temperature, humidity, door status, fluid status, nutrient status, power status, etc., and signals the status detected by each sensor to the monitoring subsystem.

The alerting subsystem is comprised of one or more of the following: an exterior audible alarm, an exterior visual alarm, and/or a digital signal transmission to at least one computing device, e.g. a smart phone, an internet connected computing device, etc.

The reporting subsystem is comprised of data transmission via a network, e.g. wireless, wired, etc. to remote computing devices, e.g. smart phones, tablets, laptops, tower computers, cloud computing, etc. of information gathered from the monitoring subsystem.

The monitoring system is further comprised of a door sensor assembly for each door that signals the status of each door (open, closed, locked, etc.).

The monitoring system is further comprised of at least one power sensor that detects interruption of power.

The monitoring system is further comprised of at least one liquid level sensor that detects when water levels in the reservoir tank drop below a predetermined level.

The monitoring system is further comprised of at least one nutrient characteristics sensor that detects when the composition of nutrient proportions is outside of a predetermined range.

The monitoring system is further comprised of at least one water pressure sensor that detects if the pressure of water being provided falls outside of predetermined levels.

The monitoring system is further comprised of at least one temperature sensor that detects when the internal temperature is outside of a predetermined range.

The monitoring system is further comprised of at least one humidity sensor that detects when the internal humidity is outside of a predetermined range.

Grains are spread on the trays and germination of the grains occurs through irrigation and climate control with optimal artificial lighting. Each tray (or group of trays is some embodiments) is accessed via its corresponding door, loaded through that door and stays within for a period of 6 to 8 days until harvested and cleaned; the germinated grains are fed to animals, provided to humans, or used for planting as desired.

In one embodiment of the technology described herein a method of making and using the insulated grain germination comprises:
a. constructing an insulated box frame with no walls on the sides and no walls on the front/back;
b. forming a large service door on the front/back side to be used when installing shelves, cleaning, servicing, or repairing the unit (the shelves, irrigation system, trays, pipes, conduit, etc.);
c. adding shelving configured to house trays (height and width of trays can vary);
d. adding side shutter-doors (bare or insulated) for each shelving level as desired configured for workers adding grain and harvesting the product, the shutter-doors can be horizontal or vertical, configuration can vary to accommodate the desired/calculated production;
e. connecting an exterior hose to the irrigation system, in the absence of pressurized water, filling a tank with clean water and connecting it to the irrigation system through a pump to allow water to travel to the grains setting on the trays;
f. adding grains to the desired tray(s);
g. closing the shutter-door until harvest time;
h. opening the target shutter-door(s);
i. pulling the product trays as desired;
j. removing the product;
k. cleaning each tray; and
l. repeating the process (f. through k.)

The climate control units need to be set initially and inspected periodically to remain in good working condition.

While the technology described herein is beneficial for providing fodder for livestock it can also benefit anyone wanting to produce plants for human consumption or for other reasons, e.g. flowers, transplanting, etc.

An aspect of the technology described herein is that it allows a person to spread the grains, wait a predetermined time, open the tray-level shutter-door, and remove the tray containing the ready to harvest germinated grains.

An aspect of the technology described herein is that it provides a unit configured for the destination climate, e.g., desert, tropical, frigid, etc.

An aspect of the technology described herein is that it provides a unit that can provide produce in remote areas that lack electricity and/or pressurized water.

There has thus been outlined, rather broadly, the features of the present invention in order that the detailed description that follows may be better understood, and in order that the present contribution to the art may be better appreciated. There are additional features of the invention that will be described and which will form the subject matter of the claims. Additional aspects and advantages of the present invention will be apparent from the following detailed description of an exemplary embodiment which is illustrated in the accompanying drawings. The invention is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The technology described herein will be better understood by reading the detailed description of the invention with reference to the accompanying drawing figures, in which like reference numerals denote similar structure and refer to like elements throughout, and in which:

FIG. 1 illustrates an insulated grain germination unit having a corresponding tray access door system, according to an embodiment of the technology described herein;

FIG. 2 illustrates the pivoting access of each corresponding tray access door, according to an embodiment of the technology described herein;

FIG. 3 illustrates additional door insulation, according to an embodiment of the technology described herein;

FIG. 4 illustrates a shelving system for an insulated grain germination unit, according to an embodiment of the technology described herein;

FIG. 5 illustrates sprouting grain in trays supported by shelves for an insulated grain germination unit, according to an embodiment of the technology described herein;

FIG. 6 illustrates a tray of sprouted grain removed from a shutter door, according to an embodiment of the technology described herein;

FIG. 7 illustrates an insulated grain germination unit, illustrating, in particular, the unit equipped with additional power sources, such as wind turbines, solar panels, and a backup battery, as well as visual and auditory alerting systems, according to an embodiment of the technology described herein;

FIG. 8 illustrates an insulated grain germination unit, illustrating, in particular, a water reservoir and a water intake hose, according to an embodiment of the technology described herein;

FIG. 9 illustrates an insulated grain germination unit, illustrating, in particular, a locking mechanism for each tray door, a monitoring system, a door sensor configured for detecting an open tray door and signaling to the monitoring system the tray door status, a temperature and humidity sensor communicating to the monitoring system the status of the internal temperature and humidity, according to an embodiment of the technology described herein;

FIG. 10 illustrates a master door linking all the insulated doors in a vertical array, illustrating, in particular, how the opening of the master door gives access to all the trays behind a vertical array of insulated doors, according to an embodiment of the technology described herein; and

FIG. 11 illustrates a method of making and using an insulated grain germination unit, illustrating, in particular, the use of tray-doors for ease of removal, minimizing degradation of growing conditions and conservation of energy.

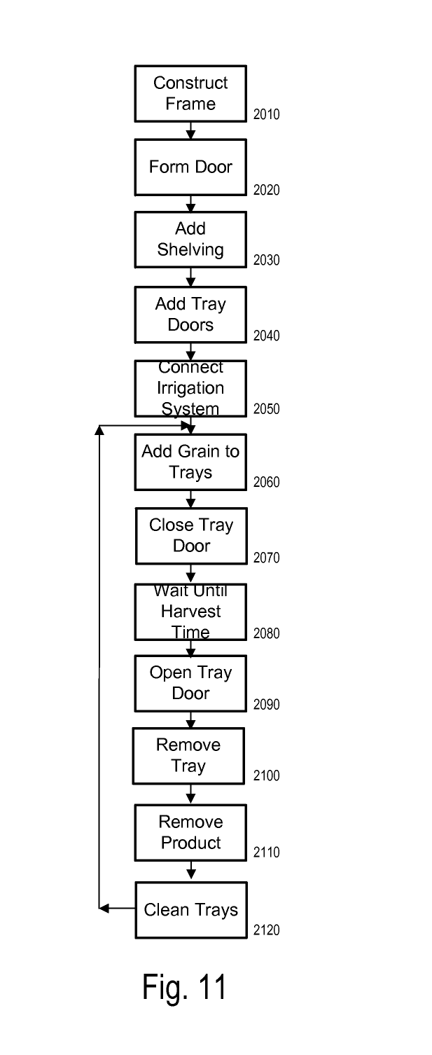

### DETAILED DESCRIPTION OF THE INVENTION

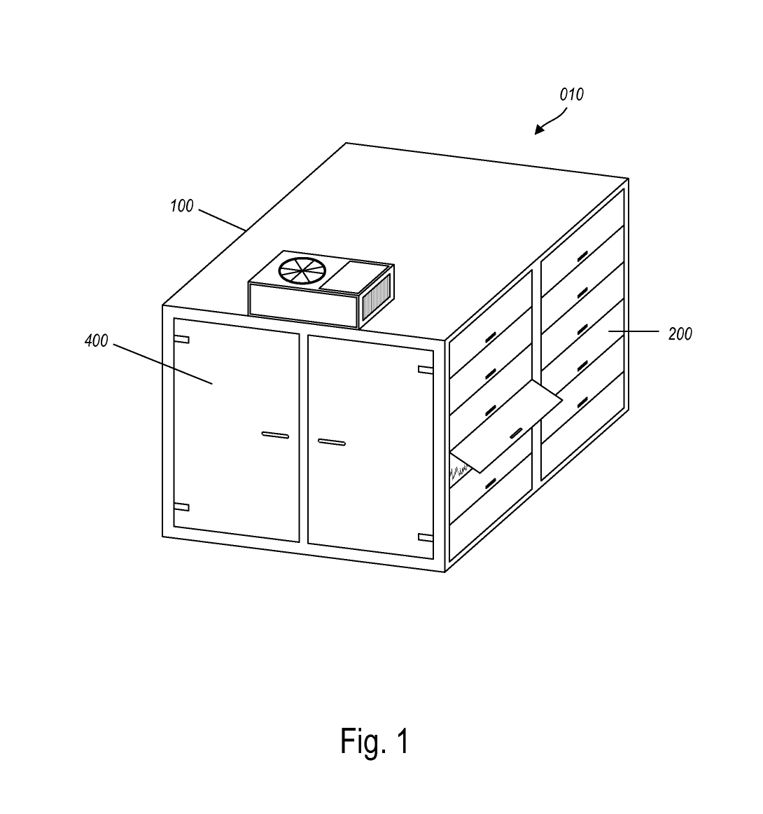

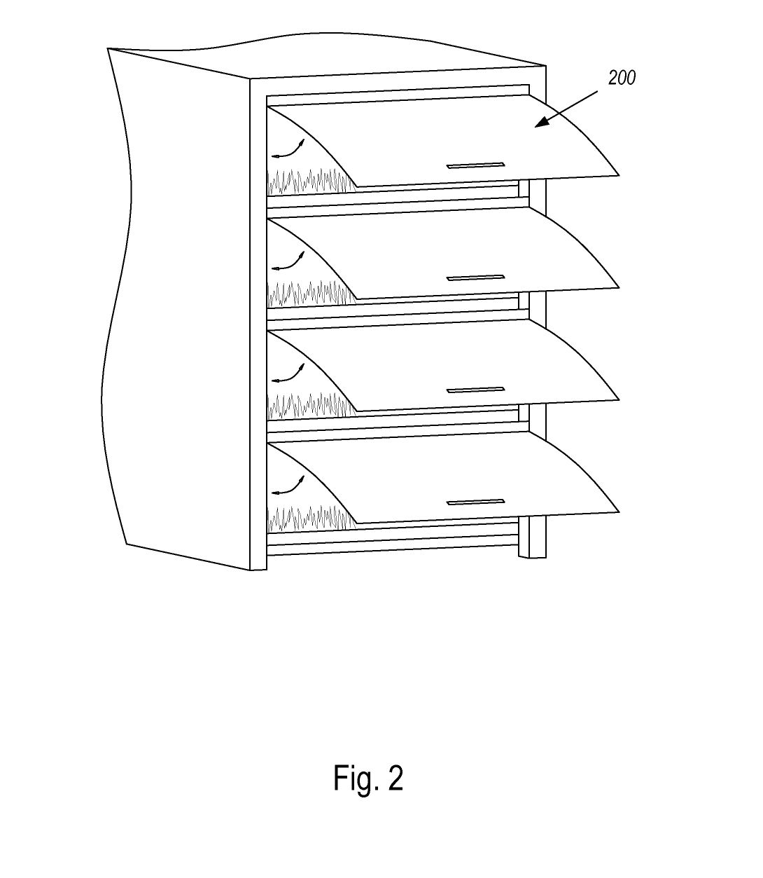

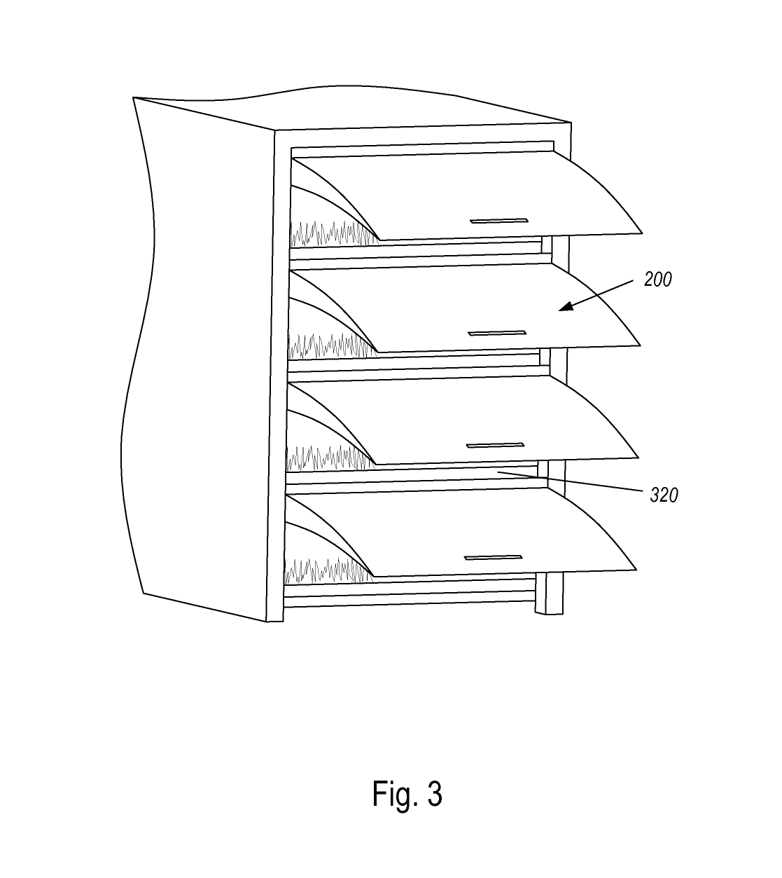

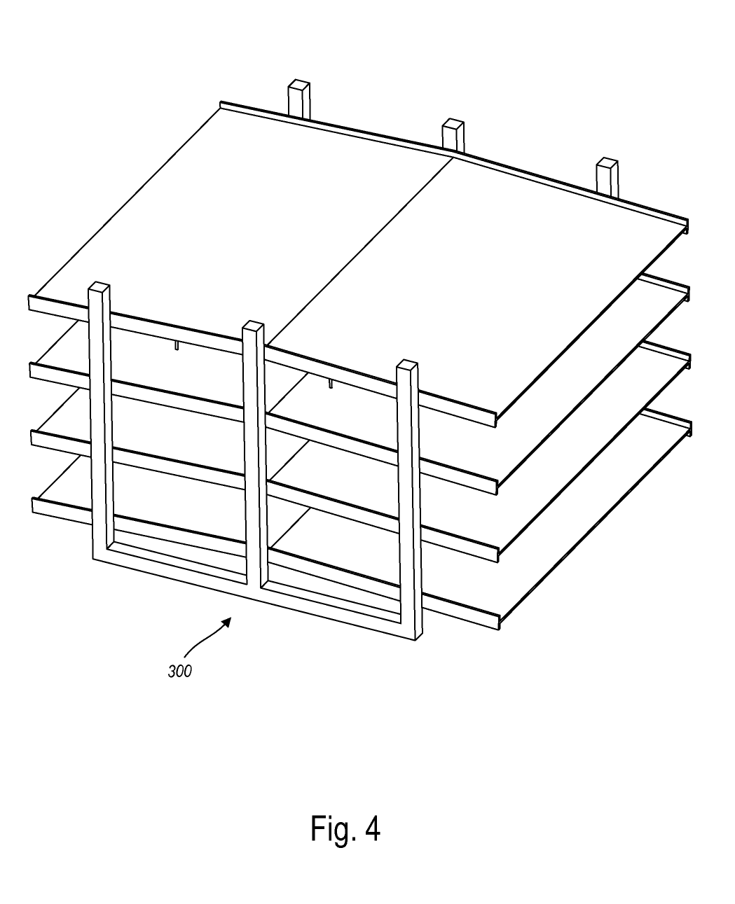

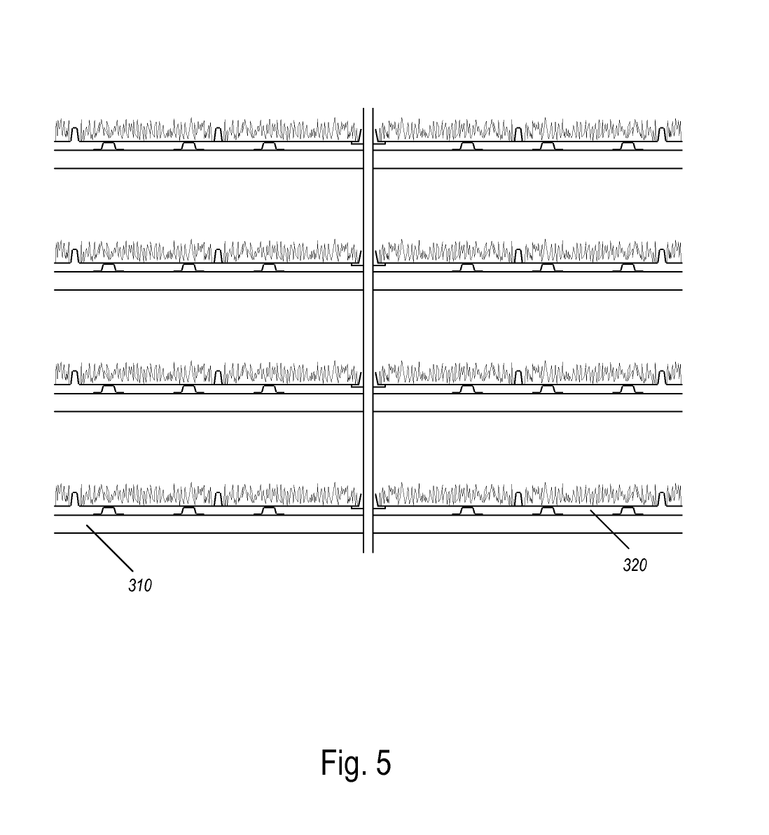

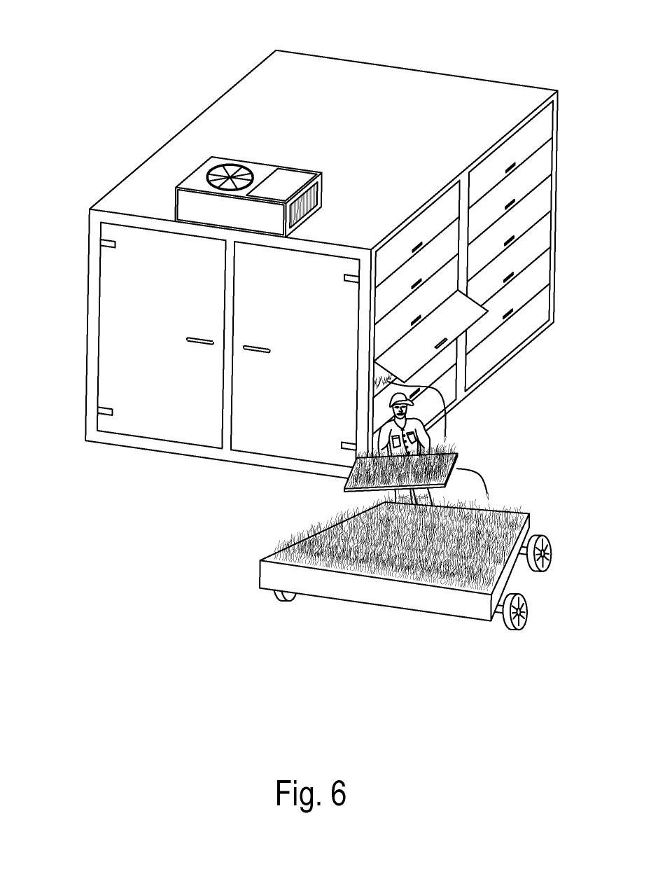

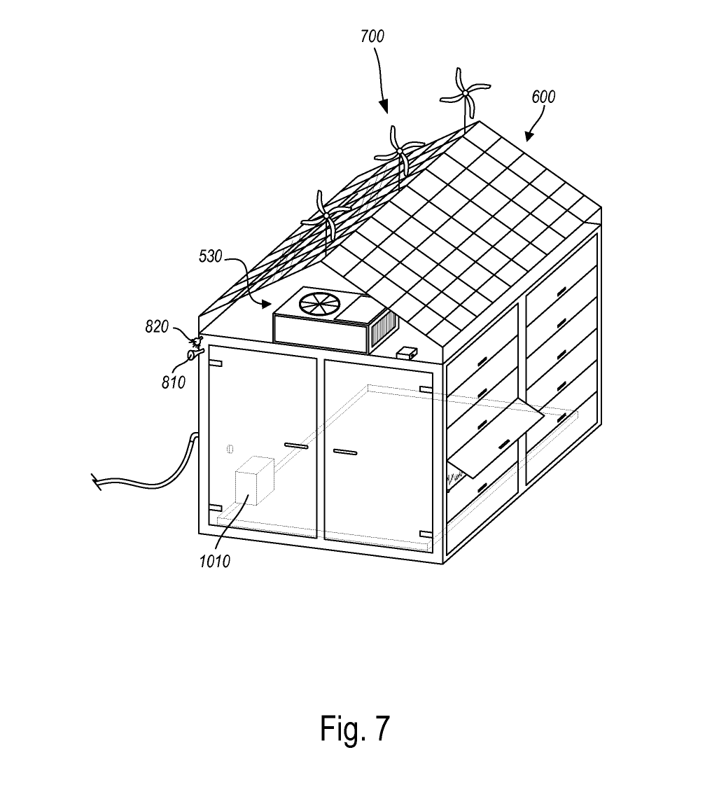

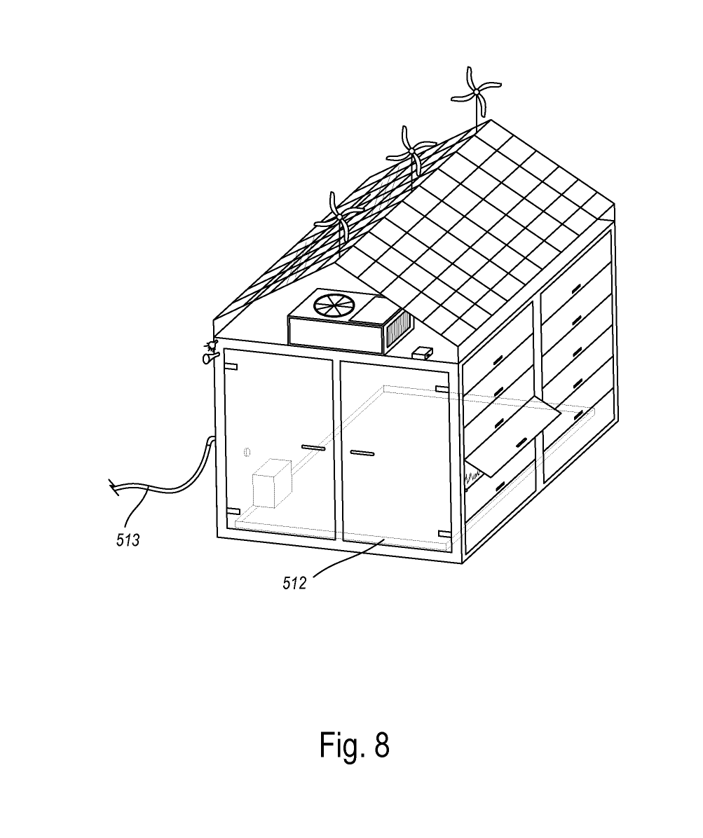

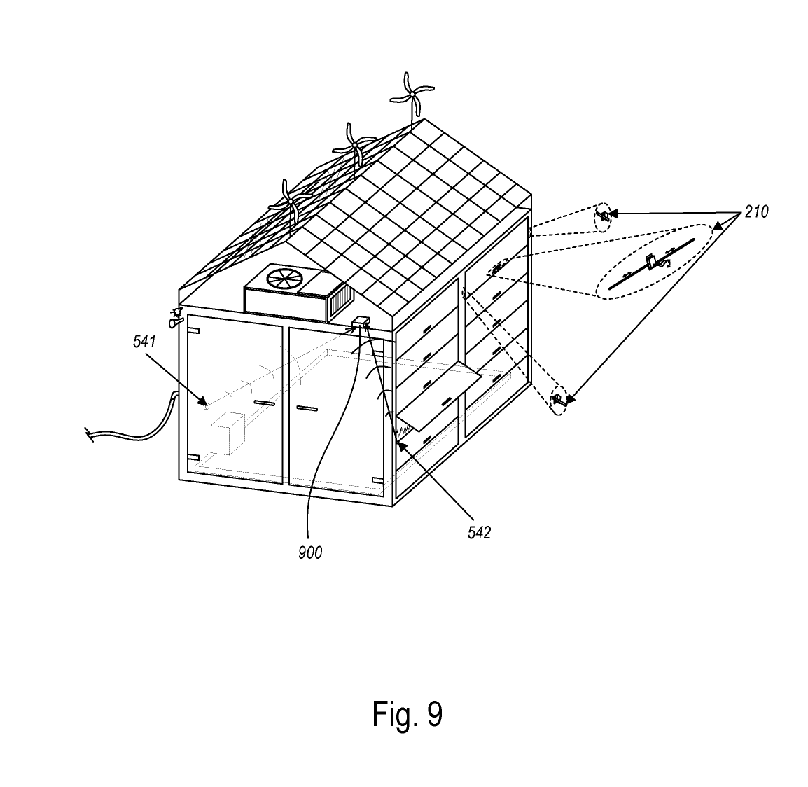

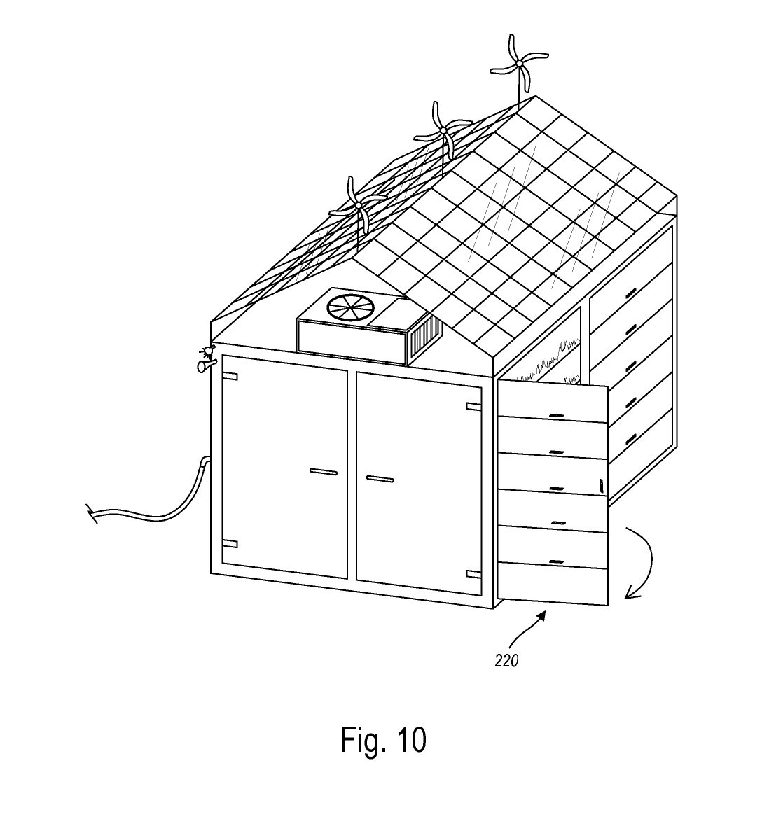

In describing the preferred and other embodiments of the technology described herein, as illustrated in FIG. 1-10, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-10, illustrated therein is an insulated grain germination unit 010.

In an exemplary embodiment of the technology described herein the insulated grain germination unit 010 is comprised of an exterior structure 100. The exterior structure is further comprised of maintenance access door 400.

The insulated grain germination unit 010 is further comprised of at least one shelving assembly 300 configured for holding a plurality of shelves 310. Each shelf 310 is configured for housing at least one tray 320. Each tray 320 and shelf 310 is configured for facilitating drainage of nutrient-rich effluents through the trays and shelves.

The insulated grain germination unit 010 is further comprised of a plurality of insulated tray door assemblies 200, each insulated tray door 200 corresponds to a particular tray 320, or set of trays, and pivots to permit access to the tray(s) 320 housed within a shelf 310. Each tray door assembly 200 is further comprised of a tray door lock assembly 210 for securing the tray door 200. Types of lock assembly 210 utilized include, but are not limited to, a hand-pressure snap-lock, a key lock, a turn-handle lock, a key card lock, or a time lock.

In some embodiments the insulated grain germination unit 010 is further comprised of a hinged master door 220 comprised of a vertical array of the tray doors 200. When the hinged master door 220 is opened, e.g. by a handle, all the trays 320 behind the tray doors 200 are accessed. This facilitates access to all trays 320 through the opening of one door, instead of having to individually open each tray door 200.

In some embodiments the insulated tray door 200 is further comprised of a viewing window configured for observing the contents of the corresponding tray.

The insulated grain germination unit 010 is further comprised of a plant growth support system that provides moisture, nutrients and proper growing conditions for the grains disposed in the trays.

The plant growth support system is comprised of an irrigation-nutrient system and a climate control system 530. In some embodiments the plant growth support system is further comprised of a lighting system.

The irrigation-nutrient system is configured for providing nutrient rich liquid to the germinating grain in each tray. The irrigation system may provide the liquid in the form of a fog, a mist, droplets etc., as desired. The irrigation system is configured to capture excess liquid after it has provided moisture and nutrients to the grains and to return the excess liquid again to each tray.

The irrigation system is further configured for capturing husks and other material that may clog the flow of liquid and for facilitating the removal of clogging material. The irrigation system may be comprised of an overhead sprinkler system or Nutrient Film Technic (NFT) or ebb-and-flow or any other mechanism or technique that provides a predetermined water quantity in preset time intervals.

The irrigation system is further comprised of a water supply connector 513, e.g. a hose connected to a pressurized water source. The irrigation system is further comprised of a water shut-off valve for each tray.

In some embodiments the irrigation system is further comprised of a water reservoir 512. The nutrients can be supplied by a separate nutrient supply source that is connected to the irrigation system or can be integrated into the irrigation system.

In some embodiments the irrigation-nutrient system is further comprised of a water pump configured to provide pressurized water when access to pressurized water is not available.

The climate control system 530 is comprised of a temperature subsystem which is configured for providing a temperature range that facilitates the germination and growth of the grains. The climate control system 530 is further comprised of at least one air movement system, e.g., at least one fan, for inducing a flow of air within the interior of the unit to facility uniform temperature and humidity.

In some embodiments a lighting system is provided and is comprised by a plurality of light sources configured for generating light conducive for stimulating growth of the germinating grain as well as providing optimum color in each seedling.

In some embodiments alternate sources of power are provided, e.g., at least one backup battery 1010, solar-power assemblies 600, wind-power assemblies 700 and the like. These can serve as backup power sources, sole power sources or complimentary power sources depending on the environment or geographical location of the grain germination unit.

The solar-power assembly 600 is comprised on solar panels disposed on or near the exterior of the unit to capture sunlight and convert the sunlight into electrical energy. The solar-power assembly is further comprised of at least one battery assembly within the unit configured for storing the electrical energy generated by the solar panels and for providing energy to the operational assemblies within the unit.

The wind-power assembly 700 is further comprised of at least one wind turbine configured to convert wind energy into electrical energy. The electrical energy thus produced can be stored in at least one battery assembly within the unit configured for storing the electrical energy generated by the wind turbine and for providing energy to the operational assemblies within the unit.

In an exemplary embodiment of the technology described herein the insulated grain germination unit 010 is further comprised of a monitoring, reporting and alerting system to ensure continuous proper growing conditions for the grains disposed in the trays.

The monitoring, reporting and alerting system is comprised of a monitoring subsystem, an alerting subsystem and a reporting subsystem.

The monitoring subsystem 900 is comprised of a sensor system configured to sense the operating conditions of the insulated grain germination unit. The sensors monitor the temperature, humidity, door status, fluid status, nutrient status, power status, etc., and signals the status detected by each sensor to the monitoring subsystem 900.

The alerting subsystem is comprised of one or more of the following: an exterior audible alarm assembly 810, an exterior visual alarm 820, and/or a digital signal transmission to at least one computing device, e.g. a smart phone, an internet connected computing device, etc.

The reporting subsystem is comprised of data transmission via a network, e.g. wireless, wired, etc. to remote computing devices, e.g. smart phones, tablets, laptops, tower computers, cloud computing, etc. of information gathered from the monitoring subsystem.

The monitoring system is further comprised of a tray door status sensor 542 for each door that signals the status of each door (open, closed, locked, etc.).

The monitoring system is further comprised of at least one power sensor that detects interruption of power.

The monitoring system is further comprised of at least one liquid level sensor that detects when water levels in the reservoir tank drop below a predetermined level.

The monitoring system is further comprised of at least one nutrient characteristics sensor that detects when the composition of nutrient proportions is outside of a predetermined range.

The monitoring system is further comprised of at least one water pressure sensor that detects if the pressure of water being provided falls outside of predetermined levels.

The monitoring system is further comprised of at least one temperature-humidity sensor 513 that detects when the internal temperature is outside of a predetermined range.

The monitoring system is further comprised of at least one humidity sensor that deters when the internal humidity is outside of a predetermined range.

Grains are spread on the trays and germination of the grains occurs through irrigation and climate control with optimal artificial lighting. Each tray is accessed via its corresponding door, loaded through that door and stays within for a period of 6 to 8 days until harvested and cleaned; the germinated grains are fed to animals, provided to humans, or used for planting as desired.

In one embodiment of the technology described herein a method of making and using the insulated grain germination using comprises:
a. 2010: constructing an insulated box frame with no walls on the sides and no walls on the front/back;
b. 2020: forming a large service door on the front/back side to be used when installing shelves, cleaning, servicing, or repairing the unit (the shelves, irrigation system, trays, pipes, conduit, etc.);
c. 2030: adding shelving configured to house trays (height and width of trays can vary);
d. 2040: adding side shutter-doors (bare or insulated) for each shelving level as desired configured for workers adding grain and harvesting the product, the shutter-doors can be horizontal or vertical, configuration can vary to accommodate the desired/calculated production;
e. 2050: connecting an exterior hose to the irrigation system, in the absence of pressurized water, filling a tank with clean water and connecting it to the irrigation system through a pump to allow water to travel to the grains setting on the trays;
f. 2060: adding grains to the desired tray(s);
g. 2070: closing the shutter-door until harvest time;
h. 2080: waiting until grain has germinated and grown as desired;
i. 2090: opening the target shutter-door(s);
j. 2100: pulling the product trays as desired;
k. 2110: removing the product;
l. 2110 cleaning each tray; and
m. repeating the process (f. through l.).

In an embodiment of the technology described herein an insulated grain germination unit comprises:
a. an exterior structure having a maintenance access door;
b. at least one shelving assembly;
c. at least one shelf, the at least one shelf configured for removable engagement on at least a portion of the shelving assembly;
d. at least one tray, the at least one tray configured for removable engagement on at least a portion of the at least one shelf;
e. at least one insulated door assembly pivotably connected to the exterior structure and configured for access to the at least one shelf; and
f. a plant growth support system, the plant growth support system configured for providing germination and growth of grains disposed upon the at least one tray, where:
   i. each shelf is configured for drainage of nutrient-rich effluents;
   ii. each tray is configured for drainage of nutrient-rich effluents;
   iii. each tray door assembly is further comprised of a tray door lock assembly for securing the tray door and has a viewing window for observing the contents of the corresponding tray(s);
   iv. a tray door lock sensor is configured for detecting and signaling a tray door lock status to an alerting system;
   v. the alerting system is comprised of an audible alarm, a visual alarm, or both;
   vi. the alerting system is further comprised of a digital signal transmitter configured for transmitting an alerting message to a computing device.

In another embodiment of the technology described herein an insulated grain germination unit comprises:
a. an exterior structure having a maintenance access door;
b. at least one shelving assembly;
c. at least one shelf, configured for drainage and removable engagement on at least a portion of the shelving assembly;
d. at least one tray, configured for drainage and removable engagement on at least a portion of the at least one shelf;
e. at least one insulated door assembly pivotably connected to the exterior structure and configured for locking and access to the at least one shelf;
f. a plant growth support system, the plant growth support system configured for facilitating germination and growth of grains disposed upon the at least one tray, and comprising an irrigation-nutrient system, a climate control system and a lighting system; alternated sources of power for powering the plant growth support system, e.g., a solar power assembly, a wind power assembly;
g. at least one battery configured for storing energy from energy sources and for automatic powering of the plant growth support system during power failures; and
h. a monitoring system, a reporting system and an alerting system, where:
   i. the alerting system comprises an exterior audible alarm and an exterior visual alarm;
   ii. the monitoring system comprises sensors configured to monitor and signal the status of temperature, humidity, nutrients, fluids, power, tray door locks;
   iii. the reporting system comprises a digital reporting device operatively in communication with the monitoring system and configured for transmitting operational information to at least one remote communication device.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered in the appended claims.

Reference Number Table

| Ref. # | Description |
|---|---|
| 010 | Insulated Grain Germination Unit |
| 100 | Exterior Structure |
| 200 | Tray Door Assembly |
| 210 | Tray Door Lock Assembly |
| 220 | Master Door Assembly |
| 300 | Shelving Assembly |
| 310 | Shelf |
| 320 | Tray |
| 400 | Maintenance Access Door |
| 500 | Plant Growth Support Assembly (not shown) |
| 510 | Irrigation Subsystem (not shown) |
| 511 | Tray Water Shut-off Valve (not shown) |
| 512 | Water Reservoir |
| 513 | Water Supply Connector |
| 520 | Nutrient Supply (not shown) |
| 530 | Climate Control Subsystem (Heating, Cooling, Air |
| | Movement, Humidity) |
| 540 | Sensor Subsystem (Status of: Tray Door, |
| | Humidity, Temperature, Water Level, Water |
| | Pressure, Nutrient Composition, Power) (Not |
| | shown) |
| 541 | Temperature and Humidity Sensor |
| 542 | Tray Door Status Sensor |
| 600 | Solar Power Assembly |
| 700 | Wind Power Assembly |
| 800 | Alerting System (not shown) |
| 810 | Audible Alerting Assembly |
| 820 | Visual Alerting Assembly |
| 900 | Monitoring System |
| 1010 | Backup Battery |
| 2010 | Construct Frame |
| 2020 | Form Door |
| 2030 | Add Shelving |
| 2040 | Add Tray Doors |
| 2050 | Connect Irrigation System |
| 2060 | Add Grain to Trays |
| 2070 | Close Tray Door |
| 2080 | Wait Until Harvest Time |
| 2090 | Open Tray Door |
| 2100 | Remove Tray |
| 2110 | Remove Product |
| 2120 | Clean Trays |

I claim:

1) An insulated grain germination unit, the insulated grain germination unit comprising:
a) an exterior structure having a maintenance access door;
b) at least one shelving assembly;
c) at least one shelf, the at least one shelf configured for removable engagement on at least a portion of the shelving assembly;
d) at least one tray, the at least one tray configured for removable engagement on at least a portion of the at least one shelf;
e) at least one insulated door assembly pivotably connected to the exterior structure and configured for access to the at least one tray; and
f) a plant growth support system, the plant growth support system configured for providing germination and growth of grains disposed upon the at least one tray.

2) The insulated grain germination unit of claim 1, each shelf configured for drainage of nutrient-rich effluents.

3) The insulated grain germination unit of claim 2, each tray configured for containing grain during germination and grown of the grain and for drainage of nutrient-rich effluents.

4) The insulated grain germination unit of claim 3, each tray door assembly further comprising a tray door lock assembly for securing the tray door.

5) The insulated grain germination unit of claim 4, further comprising a tray door lock sensor configured for detecting and signaling a tray door lock status to an alerting system.

6) The insulated grain germination unit of claim 5, the alerting system comprising an audible alarm.

7) The insulated grain germination unit of claim 5, the alerting system comprising a visual alarm.

8) The insulated grain germination unit of claim 5, the alerting system comprising a digital signal transmitter configured for transmitting an alerting message to a computing device.

9) The insulated grain germination unit of claim 4, the tray door assembly further comprising a viewing window configured for observing the contents of the tray.

10) An insulated grain germination unit, the insulated grain germination unit comprising:
a) an exterior structure having a maintenance access door;
b) at least one shelving assembly;
c) at least one shelf, the at least one shelf operably connected to the shelving assembly and configured for drainage;
d) at least one tray, the at least one tray configured for drainage and removable engagement on at least a portion of the at least one shelf;
e) at least one insulated door assembly pivotably connected to the exterior structure and configured for locking and access to the at least one shelf; and
f) a plant growth support system, the plant growth support system configured for facilitating germination and growth of grains disposed upon the at least one tray.

11) The insulated grain germination unit of claim 10, the plant growth support system comprising an irrigation-nutrient system, a climate control system and a lighting system.

12) The insulated grain germination unit of claim 11, further comprising a solar power assembly configured for converting solar energy into electrical energy for powering the plant growth support system.

13) The insulated grain germination unit of claim 11, further comprising a wind power assembly configured for converting wind energy into electrical energy for powering the plant growth support system.

14) The insulated grain germination unit of claim 11, further comprising at least one battery configured for storing energy from energy sources and for automatic powering of the plant growth support system during power failures.

15) The insulated grain germination unit of claim 11, further comprising a monitoring system, a reporting system and an alerting system.

16) The insulated grain germination unit of claim 15, the alerting system comprising an exterior audible alarm and an exterior visual alarm.

17) The insulated grain germination unit of claim 15, the monitoring system comprising sensors configured to monitor and signal the status of temperature, humidity, nutrients, fluids, power, tray door locks.

18) The insulated grain germination unit of claim 15, the reporting system comprising a digital reporting device operatively in communication with the monitoring system and configured for transmitting operational information to at least one remote communication device.

19) The insulated grain germination unit of claim 1, further comprising a hinged master door comprised of a vertical array of the at least one insulated door assembly, the hinged master door configured for access to all the at least one tray behind the at least one insulated door.
